(19) United States
(12) Patent Application Publication
(10) Pub. No.: US 2008/0270128 A1
(43) Pub. Date: Oct. 30, 2008

(54) Text Input System and Method Based on Voice Recognition

(75) Inventors: Dong-Woo Lee, Daejon (KR); Jun-Seok Park, Daejon (KR); Dong-Won Han, Daejon (KR); Il-Yeon Cho, Daejon (KR)

Correspondence Address: LADAS & PARRY LLP, 224 SOUTH MICHIGAN AVENUE, SUITE 1600, CHICAGO, IL, 60604, US

(73) Assignee: ELECTRONICS AND TELECOMMUNICATIONS RESEARCH INSTITUTE, DAEJEON (KR)

(21) Appl. No.: 12/092,790

(22) PCT Filed: Aug. 14, 2006
(86) PCT No.: PCT/KR06/03184

§ 371 Date: May 6, 2008

(30) Foreign Application Priority Data
Nov. 7, 2005 (KR) 10-2005-0106044

(51) Int. Cl. G10L 15/00

(52) U.S. Cl. 704/235; 704/E15.001

(57) ABSTRACT

Provided is a text input system and method based on voice recognition. The system includes: an input unit for receiving part of text, i.e., partial text; a voice input unit for receiving entire text of the partial text by voice; a voice recognition preprocessing unit for analyzing the voice inputted through the voice input unit and transmitting the partial text inputted through the input unit with voice analysis information; a voice recognizing unit for creating a list of a recognition candidates by using the partial text transmitted from the voice recognition preprocessing unit, performing a voice recognition and selecting a text among the recognition candidates; and an output unit for outputting a finally voice recognized text.

### TECHNICAL FIELD

The present invention relates to text input system and method based on voice recognition; and, more particularly, to text input system and method based on voice recognition that can conveniently input text including words and sentences by receiving part of the text, e.g., an initial sound of each syllable of the word, through a general input device such as a keyboard, a mouse and a pen, recognizing a corresponding voice and completing an entire text intended by a user by voice.

### BACKGROUND ART

In the present invention, a terminal means diverse information devices having an input/output function such as a wireless communication terminal, a Personal Computer (PC) and a laptop computer.

The wireless communication terminal means a terminal which can be personally carried and perform wireless communication such as a mobile communication terminal, a Personal Communication Service (PCS), a Personal Digital Assistant (PDA), a smart phone, International Mobile Telecommunication 2000 (IMT-2000), and a wireless Local Area Network (LAN) terminal.

Many input systems have been developed to reduce inconvenience on the part of the user. Examples of the input system include a keyboard, a mouse and a pen using a generally used cursive script recognition technology. However, the input devices cannot be applied to some information devices with enhanced portability and it is not comfortable for disabled people to use the devices.

Meanwhile, many researchers are studying to develop an input system based on voice recognition. However, the input system is still dependently used due to low voice recognition rate.

Korean Patent Publication No. 2005-0005819 (reference 1), published on Jan. 15, 2005, discloses a mobile terminal and method for inputting texts by using a voice recognition function. The reference 1 is a technology for inputting text to a mobile communication terminal through voice recognition by recognizing a voice through a voice recognizing unit, searching text information corresponding to the voice information in voice information managing database, and processing the text information as inputted information when the text information exists.

That is, the reference 1 makes it possible to input text without a small keypad by receiving a voice from a user in a mobile communication terminal capable of voice recognition, sequentially transforming the voice into voice data and voice information, searching text information corresponding to the voice information in voice information managing database, and processing the text information as inputted information when the text information exists.

Since the mobile communication terminal searches text information corresponding to voice information in an additional database in the cited reference 1, there is a problem that the reference 1 can be used only to input words, and it can be hardly applied to long sentences. Also, a voice recognition rate for a natural language is too low.

Korean Patent Publication No. 2004-0051317 (reference 2), published on Jun. 18, 2004, discloses a speech recognition method using utterance of the first consonant of a word and media storing thereof. The reference 2 is a technology for inputting text by recognizing the first consonant of a word, reducing a range of object vocabulary to be recognized by voice and recognizing an entire word.

That is, voice recognition object vocabularies are remarkably reduced by recognizing the first consonant of a word, i.e., reduced as much as 1/19 on an average in inverse proportion to the number of first consonants. Two same phonemes exist in pronunciation of a consonant of Korean alphabet and it is advantageous to voice recognition of a consonant.

However, it is uncomfortable that the reference 2 requires utterance activity twice. Also, since the voice recognition object vocabulary is selected through recognition of the first consonant of the word, the reference 2 is not proper to be applied to a sentence.

Meanwhile, “rotary text input device compatible with PC” is proposed in an article in The Electronics Engineers of Korea (reference 3), volume 38, No. 3, pp. 78-83. According to the reference 3, a text input device as small as a mouse (15×8) is formed to have keys of all functions accommodated by a conventional keyboard. The reference 3 selects text by rotating a jog switch at 360° in clockwise or counterclockwise and inputs the text by pressing text input key when the text is selected. Accordingly, the reference 3 provides a portable text input device compatible with a keyboard and can input a sentence.

In the technology proposed in the reference 3, text is inputted by using both of a conventional text input method and text rotating method. However, there is a problem that the key input method is not comfortable for a user having difficulty in key control.

### DISCLOSURE OF INVENTION

### Technical Problem

It is, therefore, an object of the present invention to provide text input system and method adopting voice recognition that can conveniently input text including words and sentences by receiving part of the text, e.g., an initial sound of each syllable of the word, through a general input device such as a keyboard, a mouse and a pen, recognizing a user voice corresponding voice and completing entire text intended by a user by the user's voice.

That is, the present invention provides text input system and method based on voice recognition which is capable of inputting a desired text through utterance activity without individually inputting an entire text including words and sentences with a keyboard, a mouse and a pen by simultaneously using a general input device and a voice recognition device, and raises a voice recognition rate by simply inputting part of the text.

Other objects and advantages of the invention will be understood by the following description and become more apparent from the embodiments in accordance with the present invention, which are set forth hereinafter. It will be also apparent that objects and advantages of the invention can be embodied easily by the means defined in claims and combinations thereof.

### Technical Solution

In accordance with one aspect of the present invention, there is provided text input system based on voice recognition, the system including: an input unit for receiving part of text, i.e., a partial text; a voice input unit for receiving entire text of the partial text by voice; a voice recognition preprocessing unit for analyzing the voice inputted through the voice input unit and transmitting the partial text inputted through the input unit with voice analysis information; a voice recognizing unit for creating a list of a recognition candidates by using the partial text transmitted from the voice recognition preprocessing unit, performing a voice recognition and selecting text among the recognition candidates; and an output unit for outputting a finally voice recognized text.

In accordance with another aspect of the present invention, there is provided text input method based on voice recognition in text input system, including the steps of: a) receiving part of text, i.e., a partial text; b) receiving an entire text of the partial text by voice; c) analyzing the inputted voice data for voice recognition; d) creating a list of recognition candidates by using the inputted partial text; e) performing voice recognition and selecting one among the recognition candidates; and f) outputting the finally voice recognized text.

### ADVANTAGEOUS EFFECTS

Since the entire text data are inputted by using a partial text input through a general input device, e.g., a keyboard, and voice recognition in the present invention, a voice recognition rate is raised in comparison with a conventional input system based on voice recognition and the number of key manipulation is reduced. Accordingly, the present invention makes it possible to conveniently input text.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram showing text input system based on voice recognition in accordance with an embodiment of the present invention;

FIG. 2 is a flowchart describing text input method based on voice recognition in the text input system in accordance with an embodiment of the present invention;

FIG. 3 shows text input procedure in a web page employing the text input system in accordance with an embodiment of the present invention; and

FIG. 4 shows partial input examples of a word and a sentence in the text input system in accordance with the embodiment of the present invention.

### BEST MODE FOR CARRYING OUT THE INVENTION

Other objects and advantages of the present invention will become apparent from the following description of the embodiments with reference to the accompanying drawings. Therefore, those skilled in the art that the present invention is included can embody the technological concept and scope of the invention easily. In addition, if it is considered that detailed description on prior art may obscure the points of the present invention, the detailed description will not be provided herein. The preferred embodiments of the present invention will be described in detail hereinafter with reference to the attached drawings.

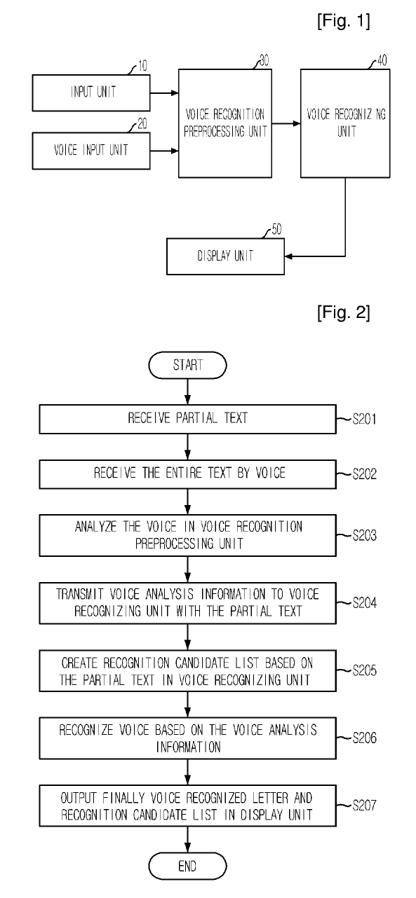

FIG. 1 shows text input system based on voice recognition in accordance with an embodiment of the present invention.

The text input system based on voice recognition of the present invention includes an input unit 10 for receiving part of text, i.e., a partial text, e.g., an initial sound of each syllable in a word, a voice input unit 20 for receiving a user's voice, a voice recognition preprocessing unit 30, a voice recognizing unit 40 and a display unit 50 for displaying diverse screens.

The voice recognition preprocessing unit 30 extracts a start point, an end point and features of a voice required for voice recognition and transmits the extracted points and features with a partial text inputted through the input unit 10 to the voice recognizing unit 40.

The voice recognizing unit 40 creates a list of more than one recognition candidates based on the partial text transmitted from the voice recognition preprocessing unit 30, performs voice recognition, selects text including a word and a sentence having the highest recognition value among the recognition candidates and outputs the text through the display unit 50. The voice recognizing unit 40 can output a recognition candidate list through the display unit 50 as well as the text having the highest recognition value among the recognition candidates.

The input unit 10 means a general input device such as a keyboard, a soft keyboard, a mouse and a pen and it receives a partial text. For example, the general input device receives [symbol] in a word [symbol] and [symbol] in a sentence

[symbol]

When the voice input unit 20 receives a voice of the user through a micro phone, the voice input unit 20 receives entire text including words or sentences spoken by the user in the form of voice.

The voice recognition preprocessing unit 30 receives part of the text, i.e., partial text, through the input unit 10 and transmits the partial text to the voice recognizing unit 40 for creation of the recognition candidate list. Subsequently, the voice recognition preprocessing unit 30 receives a user voice of an entire text through the voice input unit 20, extracts a start point, an end point and a feature of the voice and transmits the extracts to the voice recognizing unit 40 for voice recognition. That is, the voice recognition preprocessing unit 30 analyzes the user voice and transmits a voice analysis result to the voice recognizing unit 40.

The voice recognizing unit 40 receives the partial text from the voice recognition preprocessing unit 30, selects more than one recognition candidate and creates a recognition candidate list. Also, the voice recognizing unit 40 sequentially receives the voice analysis information for the entire text, e.g., the start point, the end point and the features of the voice, recognizes the voice and selects text of the highest recognition value in the created recognition candidate list.

The voice recognizing unit 40 can remotely transmit/receive data with other constituent elements based on the performance of the terminal applying the text input system in the present invention such as a wireless communication terminal, PC and a laptop computer. For example, the voice recognizing unit 40 can be connected with other constituent elements through the Internet.

The display unit 50 outputs voice-recognized text finally by the voice recognizing u nit 40, i.e., text having the highest recognition value among more than one recognition candidate, and a recognition candidate list to the user through a screen. The display unit 50 designates a general display device such as a Liquid Crystal Display (LCD).

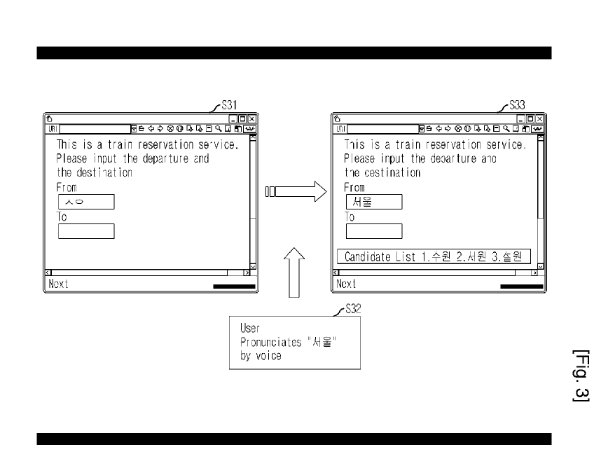

FIG. 2 is a flowchart describing text input method based on voice recognition in the text input system in accordance with an embodiment of the present invention.

The input unit 10 receives a partial text at step S201. For example, the input unit 10 receives a part of a word or a sentence such as [symbol] and

[symbol]

The voice input unit 20 receives the entire text of the partially transmitted words by voice at step S202.

The voice recognition preprocessing unit 30 analyzes the voice transmitted through the voice input unit 20 at step S203, and transmits the voice analysis information including a start point, an end point and a feature of the voice to the voice recognizing unit 40 with the partial text transmitted through the input unit 10 at step S204.

The voice recognizing unit 40 creates a recognition candidate list by using the partial text transmitted from the voice recognition preprocessing unit 30 at step S205. That is, the voice recognizing unit 40 selects more than one recognition candidate text including a word or a sentence. Subsequently, the voice recognizing unit 40 recognizes the voice based on the transmitted voice analysis information at step S206. That is, text is finally selected among recognition candidates included in the created recognition candidate list.

The display unit 50 simultaneously outputs the text which is finally recognized by voice in the voice recognizing unit 40 along with a recognition candidate list at step S207.

FIG. 3 shows text input procedure in a web page employing the text input system in accordance with an embodiment of the present invention.

The text input system of the present invention is applied to a user terminal and a web service system such as a train reservation service system, receives a partial text from the user through a web page and can output entire text finally recognized by voice through the web page. The voice recognizing unit 40 of the text input system exists not in the user terminal but in the web service system apart from other constituent elements.

For example, the user terminal receives [symbol] i.e., partial text, on the web page at step S31, and receives a user voice saying [symbol] at step S32. Subsequently, the user terminal transmits the partial text with the voice analysis information for the user voice to the voice recognizing unit 40 in the web service system through the Internet, receives text which is finally recognized by voice and a recognition candidate list as the result and outputs the recognized text and the recognition candidate list to the user on the web page at step S33.

The voice-recognized text is [symbol] and the recognition candidate list includes [symbol] and [symbol] It is preferred that each recognition candidate text is sequentially arranged according to recognition values.

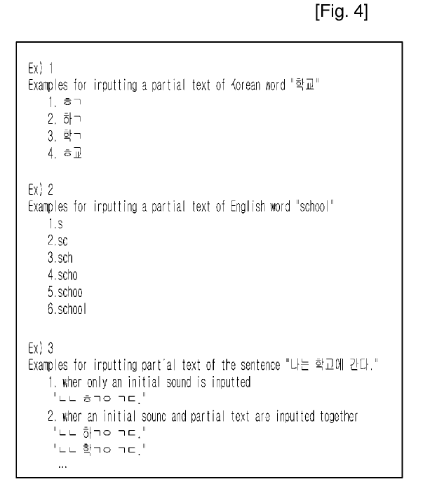

FIG. 4 shows partial input examples of a word and a sentence in the text input system in accordance with the embodiment of the present invention.

Referring to example 1, when the user inputs the Korean word [symbol] an initial sound of each syllable in a word can be inputted as a partial text such as [symbol] or [symbol] In addition, the initial sound can be inputted as [symbol] and

[symbol]

Referring to example 2, when the user inputs an English word “school”, partial texts such as “s”, “sc”, “sch” and “scho” can be inputted.

Referring to example 3, when the user inputs a Korean sentence [symbol] an initial sound of each syllable can be inputted as a partial text such as [symbol] It is also possible to input the initial sound with some medial sounds such as [symbol] or

[symbol]

The present invention increases a voice recognition rate in comparison with a conventional voice recognition input system by simultaneously inputting partial text and voice data for recognition, and it can input text more conveniently than a general input device where text is inputted only by keys.

For example, when [symbol] is inputted with a keyboard among general input devices, key input is required as much as 17 times. However, the text input system of the present invention requires key input of only 7 times and one utterance activity to input the sentence. In particular, disabled people can conveniently use the text input system.

As described in detail, the present invention can be embodied as a program and stored in a computer-readable recording medium, such as CD-ROM, RAM, ROM, a floppy disk, a hard disk and a magneto-optical disk. Since the process can be easily implemented by those skilled in the art, further description will not be provided herein.

The present application contains subject matter related to Korean patent application No. 2005-0106044, filed in the Korean Intellectual Property Office on Nov. 7, 2005, the entire contents of which are incorporated herein by reference.

While the present invention has been described with respect to certain preferred embodiments, it will be apparent to those skilled in the art that various changes and modifications may be made without departing from the scope of the invention as defined in the following claims.

1. A text input system based on voice recognition, comprising:
an input means for receiving part of text, i.e., partial text;
a voice input means for receiving entire text of the partial text by voice;
a voice recognition preprocessing means for analyzing the voice inputted through the voice input means and transmitting the partial text inputted through the input means with voice analysis information;
a voice recognizing means for creating a list of recognition candidates by using the partial text transmitted from the voice recognition preprocessing means, performing a voice recognition and selecting a text among the recognition candidates; and
an output means for outputting a finally voice recognized text.

2. The system as recited in claim 1, wherein the output means further outputs the recognition candidate list.

3. The system as recited in claim 2, wherein the output means sequentially outputs a plurality of recognition candidates included in the recognition candidate list according to each recognition value.

4. The system as recited in claim 1, wherein the voice recognition preprocessing means extracts a start point, an end point and features of the voice inputted through the voice input means and transmits the extracted points and features to the voice recognizing means.

5. The system as recited in claim 4, wherein the text includes a word and a sentence.

6. A text input method based on voice recognition in a text input system, comprising the steps of:
a) receiving part of text, i.e., partial text;
b) receiving entire text of the partial text by voice;
c) analyzing the inputted voice data for voice recognition;
d) creating a list of recognition candidates by using the inputted partial text;
e) performing voice recognition and selecting one among the recognition candidates; and
f) outputting the finally voice recognized text.

7. The method as recited in claim 6, wherein the recognition candidate list is outputted together with the voice-recognized text in the step f).

8. The method as recited in claim 7, wherein the recognition candidates included in the recognition candidate list are sequentially outputted according to each recognition value in the step f).

9. The method as recited in claim 6, wherein a start point, an end point and features of the voice are extracted in the step c).

10. The method as recited in claim 9, wherein the text includes a word and a sentence.
